(19) United States
(12) Patent Application Publication
(10) Pub. No.: US 2026/0337418 A1
(43) Pub. Date: Oct. 29, 2026

(54) POWDER COATING COMPOSITION COMPRISING DRY BLENDED COMPONENTS

(71) Applicant: Akzo Nobel Coatings International B.V., Amsterdam (NL)

(72) Inventors: Maria Jose Gonzalez Alvarez, Amsterdam (NL); Kevin Jeffrey Kittle, Amsterdam (NL)

(21) Appl. No.: 19/116,167

(22) PCT Filed: Oct. 10, 2023
(86) PCT No.: PCT/EP2023/078078

§ 371 Date: Mar. 27, 2025

(30) Foreign Application Priority Data
Oct. 12, 2022 (EP) 22201103.3

(51) Int. Cl. C09D 5/03; C09D 7/61; C09D 167/00

(52) U.S. Cl. CPC C09D 5/031; C09D 7/61; C09D 167/00

(57) ABSTRACT

The disclosure relates to a powder coating composition comprising a first powder coating component dry blended with a second powder coating component. The first powder coating component comprises a curable resin, and the second powder coating component comprises a powdered organic polymer or resin with a particle size distribution in which the Dᵥ90 value and/or the Dᵥ50 value is less than that of the first powder coating component. In addition, the Dᵥ90 value of the second powder coating component is 50 μm or less and/or the Dᵥ50 value of the second powder coating component is 30 μm or less.

### CROSS REFERENCE TO RELATED APPLICATION

This application is a 35 U.S.C. § 371 national phase application of PCT Application No. PCT/EP2023/078078 (published as WO/2024/079131), filed Oct. 10, 2023, which claims the benefit of priority to EP Application Serial No. 22201103.3, filed Oct. 12, 2022, each of which is incorporated herein by reference in their entirety.

### TECHNICAL FIELD

The disclosure relates to a powder coating composition comprising dry blended components. The disclosure also relates to a substrate coated with such a powder coating composition, and also a method for coating a substrate with such a powder coating composition.

### BACKGROUND

Powder coating compositions are solid compositions that generally comprise a solid film-forming (binder) polymer or mixtures of different solid film-forming polymers. The compositions can also comprise other components, for example pigments, extenders and one or more performance additives such as plasticizers, stabilizers, degassing agents, and flow aids. The film-forming polymers are usually thermosetting polymers that cure upon heating, typically in the presence of a crosslinking agent, which may itself be a polymer. Generally, the polymers have a glass transition temperature (Tg), softening point or melting point above 30 °C.

Conventionally, the manufacture of a powder coating composition comprises melt-mixing the components of the composition. Melt-mixing involves high speed, high intensity mixing of dry ingredients followed by heating of the mixture to a temperature above the softening temperature of the uncured polymer, but below the curing temperature, in a continuous compounder such as a single or twin-screw extruder to form a molten mixture. The extruded molten mixture is rolled into the shape of a sheet, cooled to solidify the mixture, crushed into flakes, and then pulverized to a fine powder. Generally, the powder is then subjected to a sequence of particle sizing and separation operations, such as grinding, classifying, sifting, screening, cyclone separation, sieving and filtering.

The thus-obtained powder coating composition is then applied to a substrate and heated to melt and fuse the particles and to cure the coating. Powder coating compositions may be applied by fluidized-bed processes wherein the substrate is preheated and dipped in a fluidized bed of the powder resulting in the powder fusing on contact with hot surface and adhering to the substrate, by electrostatic fluidized-bed processes, or by electrostatic spray processes wherein the powder coating particles are electrostatically charged by electrodes within a fluidized bed or by an electrostatic spray gun and directed to be deposited onto an earthed substrate.

Powder coating compositions are generally formulated as so-called one-component compositions prepared by melt-mixing all ingredients together. It is believed that melt-mixing all ingredients is needed in order to mix film-forming compounds (curable resin(s) and curing additives), pigments and performance additives in close proximity to each other so that they can coalescence and cure to form a coherent coating with integrity and the desired properties. Occasionally small amounts of solid additive, typically up to 1 wt %, are dry-mixed with the powder coating particles formed by melt-mixing, in particular to improve flowability (so-called dry flow agents).

Other particulate additives, for example matting agents such as silica, extenders, colour pigments, biocidal pigments, and corrosion inhibiting pigments, are typically incorporated in the powder coating particles during melt-mixing. The particulate additive is therefore embedded in resin, which may negatively affect its functionality. The amount of particulate additive that can be added in a melt-mixing step is limited in view of processability. Moreover, a high amount of particulate additive would lead to unacceptably reduced surface flow during curing of the powder coating.

Pigments with a metallic effect, such as metallic flakes or mica flakes, are typically not added during the melt-mixing step, since the pigment flakes would be crushed during the subsequent milling step, which would be detrimental to the metallic effect. Typically, such flakes are therefore added to powder coating compositions in a so-called bonding step. Such bonding step is known in the art and typically comprises: heating powder coating particles (obtained by melt-mixing as described above) to a temperature around the glass transition temperature but below the curing temperature of any binder polymer in the powder coating particles under an inert atmosphere; adding the pigment flakes with metallic effect to the heated powder coating particles under stirring whilst maintaining the temperature until the pigment flake is bonded to the powder coating particles, typically for 10-20 minutes; and cooling the powder coating composition.

Such bonding step is, however, time and energy intensive and is restrictive in terms of batch size and the amount of pigment that can be used. The bonding process, moreover, easily breaks the pigment flakes.

Pigments with a metallic effect can be dry-blended with the powder coating particles. However, these compositions generally show less stability in spray application, reduced fluidity, and less surface appearance due to flake agglomeration and uneven coverage of the metallic flakes.

WO 00/01774 discloses a powder coating composition comprising film-forming polymeric powder coating particles with a standard particle size distribution, dry-blended therewith at least one appearance-modifying additive and a further additive comprising wax-coated silica or consisting of alumina together with aluminium hydroxide. The appearance-modifying additive(s) in WO 00/01774 may be coloured polymeric material, a fine powder of polymeric material for glass reduction, polymeric texturing additive(s), or mica pigments or other lustre pigments in an amount up to 10 wt %.

There is a need for powder coating compositions in a variety of aesthetic effects or a variety of functionality wherein the aesthetic effect or functionality can be controlled whilst avoiding processability problems.

### SUMMARY

It has now been found that a functional particulate additive, such as pigments with metallic effect or other functional pigments, that would normally not pass through a melt-mixing step without affecting the functionality or the amount that can be added, can be dry-blended with a powder coating component, even in relatively high amounts, without negatively affecting the processability whilst still achieving a coherent film with desired film properties. This can be achieved by adding or dry-blending a specific type of particulate additive with the powder coating component.

Accordingly, the disclosure provides a powder coating composition comprising a first powder coating component dry blended with a second powder coating component, in which the first powder coating component comprises a curable resin, and the second powder coating component comprises a powdered organic polymer or resin.

The particle size distribution of the first and second powder coating components are different. The second powder coating component has a smaller Dᵥ90 and/or Dᵥ50 value than the first powder coating component. The second powder coating component has a Dᵥ90 of 50 μm or less and/or a Dᵥ50 value of 30 μm or less.

In a second aspect, the disclosure provides a method for coating a substrate with such a powder coating composition.

In a third aspect, the disclosure provides a substrate coated with such a powder coating composition.

In a fourth aspect, the disclosure provides a method for producing a such powder coating composition.

### DETAILED DESCRIPTION

The powder coating composition according to the disclosure comprises a first powder coating component, which may be abbreviated below to the “first component”. The first component comprises one or more curable resins. The first component may also be referred to as the “binder”.

The powder coating composition also comprises a second powder coating component, which may be abbreviated below to “second component”.

The first and second powder coating components are each made up of powder particles. The individual powder particles in each powder coating component can comprise one or more materials.

The powder coating composition can comprise one or more curing additives for curing the one or more curable resins. These can be incorporated into the powder particles of the first powder coating component, or they can be incorporated into the powder particles of the second powder coating. Alternatively, they can be separately dry blended together with the first and second powder coating components. Typically, the powder coating composition comprises one or more curing additives in the first powder coating component.

Reference herein to a curing additive is to a compound that enables the curing of the curable resin, such as a curing agent that crosslinks with the curable resin, or that affects the speed of the curing reaction, such as a curing catalyst, a free-radical initiator such as a thermal radical initiator or a photo initiator, an accelerator, or an inhibitor. Reference herein to a curing catalyst is to a compound that catalyzes the cross-linking reaction between curable resin and a crosslinking curing agent, or, in case of a self-crosslinking curable resin, catalyzes the self-crosslinking reaction.

The one or more curing additives for curing the curable resin preferably comprise a curing agent that crosslinks with the curable resin and/or a curing catalyst. A crosslinking curing agent may be a resin itself, such as an epoxy resin that crosslinks with a carboxyl-functional polyester resin, or a polyamine resin that crosslinks with an epoxy resin.

The term “curing system” can be used to include the curable resin and one or more curing additives. It will be appreciated that in case of a curing system with a curable resin and a curing agent that is a resin itself, any of the two resins can be considered the curable resin or the curing additive.

### [First Powder Coating Component]

Where the powder particles of the first powder coating component comprise more than one material, they can be obtained by melt-mixing the constituent ingredients in a compounder such as an extruder. When melt-mixing is employed, the powder particles of the first powder coating component comprise a polymer that is able to soften, i.e. melt, in the compounder. This polymer may be the curable resin and/or a curing agent for the curable resin that is a resin in itself. Further powder coating ingredients can optionally also be included, such as pigment, extender, or performance additive(s), for example melt flow agent, degassing agent, or dispersing agent.

The first powder coating composition typically comprises all of the curable resin and the one or more curing additives.

The powder particles of the first powder coating component are larger than those of second powder coating component. Thus, the Dᵥ90 and/or Dᵥ50 particle size distribution for the first component are greater than those of the second component. In embodiments, the first powder coating component has a particle size distribution with a Dᵥ90 of at most 150 μm and a Dᵥ50 of at most 75 μm, for example a Dᵥ90 of at most 120 μm and a Dᵥ50 of at most 50 μm, such as at most 40 μm. In further embodiments, the Dᵥ90 is not lower than 30 μm and the Dᵥ50 is not lower than 20 μm. Thus, example Dᵥ90 ranges include from 20 to 150 μm, from 20 to 75 μm, from 20 to 50 μm, from 30 to 150 μm, from 30 to 75 μm and from 30 to 50 μm.

Dᵥ90 is the particle size value at which 90% of the total volume of particles has a particle size below that value, and Dᵥ50 is the particle size value at which 50% of the total volume of particles has a particle size below that value. A typical method for measuring Dᵥ90 or Dᵥ50 is laser diffraction according to ISO 13320, which in embodiments can use the Mie model.

The first powder coating component, in embodiments, comprises so-called “bonded” powder coating particles. This means that the binder-containing first powder coating component particles comprise not only binder materials and other components in any particles formed from melt-mixing and extrusion, but also particles of one or more additives that are subsequently bonded to these particles. Bonding of additive particles (e.g. pigment particles) to binder-containing particles is known in the art, and is typically achieved by heating the powder coating composition to a heating temperature around the glass transition temperature but below the curing temperature of any binder polymer in the powder coating composition, under an inert atmosphere; adding the additive (such as a solid pigment) to the heated powder coating composition under stirring whilst maintaining the heating temperature until the additive is bonded to the powder coating particles, typically after 10-20 minutes; and cooling the powder coating composition.

The term “curing system” can be used to describe the combination of a curable resin and one or more curing additives known to be suitable for powder coating compositions.

Suitable curable resins are, for example, carboxyl-functional resins such as carboxyl-functional polyesters, polyester-amide or (meth)acrylate-based resins; amine-functional resins such as polyamide or polyester-amide resins; hydroxyl-functional resins such as hydroxy-functional polyesters; epoxy-functional resins (including glycidyl-functional resins); anhydride-functional resins; and resins with unsaturated bonds such as unsaturated polyesters.

Curing additives such as crosslinking curing agents or curing catalysts for curing such curable resins are well known in the art. Suitable curing additives for curing carboxyl-functional resins are for example β-hydroxyalkylamides or polyisocyanates such as triglycidyl isocyanurate.

The first powder coating component comprises a curable resin. In one embodiment, the curable resin is a carboxyl-functional polyester, carboxyl-functional polyacrylate, hydroxy-functional polyester or hydroxy-functional polyacrylate. In embodiments, it is a carboxyl- or hydroxyl-functional polyester. Any of these can be used in combination with one or more curing additives selected from a β-hydroxyalkylamide or a polyisocyanate such as triglycidyl isocyanurate. Preferably, the curable resin is carboxyl-functional polyester or hydroxyl-functional polyester, and the one or more curing additives comprise a β-hydroxyalkylamide as crosslinking agent.

In other embodiments, the curing system may suitably be an epoxy-polyester system or an epoxy-amine system. In an epoxy-polyester curing system, the one or more curing additives is an epoxy resin and the curable resin is a polyester resin with crosslinkable functional groups. The epoxy resin crosslinks with the functional groups on the polyester resin. In an epoxy-amine curing system, the one or more curing additives is a polyamine resin and the curable resin is an epoxy resin. The polyamine resin acts as curing agent that crosslinks the epoxy resin.

In one embodiment, the curing system is capable of curing at a temperature below 160 °C.

### [Second Powder Coating Component]

The powder coating composition comprises a dry-blended second powder coating component. This second component is or comprises particles of an organic polymer or resin. Where the particles comprise other components or additives, the content of organic polymer is typically at least 60 wt %, for example at least 70 wt %.

In embodiments, the organic polymer or resin of the second component is chemically different from the curable resin of the first component. The powder particles comprising the organic polymer or resin has a particle size distribution in which the Dᵥ90 and/or Dᵥ50 are lower than that of the first powder coating component. In embodiments, the Dᵥ90 is 50 μm or less, for example 40 μm or less, such as 30 μm or less, 25 μm or less. In embodiments, the Dᵥ90 is at least 3 μm, for example at least 5 μm. In embodiments, the Dᵥ90 values can fall in the range of from 3 to 50 μm, from 3 to 40 μm, from 3 to 30 μm or from 3 to 25 μm. In embodiments, the particle size distribution also or alternatively has a Dᵥ50 of 30 μm or less, for example 20 μm or less, such as 10 μm or less. In further embodiments, the Dᵥ50 value is at least 1 μm, and the range of Dᵥ50 values can be from 1 to 30 μm, from 1 to 20 μm or from 1 to 10 μm.

Particles having such characteristics can be produced by jet-milling, and hence in embodiments they are so-called jet-milled powders.

In embodiments, the second powder coating component has a particle size distribution such that the ratio between Dᵥ90 and Dᵥ50 is in the range of from 1.5 to 4.0.

In embodiments, the second powder coating component is the most negatively charged powder coating component relative to the first powder coating component, and also compared to any other dry blended components of the coating composition. Generally speaking, smaller organic particles tend to have higher charge/mass ratios than larger organic particles. Use of certain additives can also modify this difference in charge/mass ratio.

In embodiments, the second powder coating component comprises one or more polymers or resins selected from polyesters, polyurethanes, polyureas, epoxy resins, polycarbonates, any combination of two or more thereof, and polymers or resins having characteristics of any two or more thereof. The polymer is typically one that is functional and/or curable, such that it can form chemical bonds with materials in the first powder coating component. For example, the organic polymer can be a hydroxy or carboxyl-functional organic polymer. In other embodiments, it can be a curable polymer, such that the second powder coating component comprises both the organic polymer and a curing agent/hardener or cross-linking agent.

In embodiments the organic polymer is selected from polyesters and polyurethanes. In embodiments, the second powder coating component comprises an organic polymer and a hardener/curing agent, e.g. a polyester and an isocyanate, or a polyester and a hydroxyalkylamide such as beta-hydroxyalkylamide.

In embodiments, the powder coating composition comprises in the range of from 0.1 to 25 wt %, preferably from 0.2 to 15, more preferably from 0.3 to 8.0 wt %, of the second powder coating component.

### [Additives]

The powder coating composition can comprise one or more additives, which are different to the second powder coating component. In embodiments, these can be selected from stabilisers, levelling agents, anti-settling agents, matting agents, rheology modifiers, anticorrosion agents, flexibility agents, surface-active agents, UV light absorbers, light stabilisers, amine synergists, waxes, adhesion promoters, fillers, pigments, flow control agents, degassing agents, and antioxidants.

The total quantities of these additional components can be in the range of from 0 to 40 wt %, for example from 0 to 35 wt %, or from 0 to 30 wt %. Where any of such additional components are present, their minimum concentration (individually or cumulatively) is typically at least 0.05 wt % in the powder coating composition, for example at least 0.1 wt %.

Each additive can have an average particle size (Dᵥ50) in the range of from 5 to 100 μm, for example from 5 to 50 μm.

Any one or more of these additives can be incorporated into the first powder coating component, for example by being included in an extrudate together with the curing system ingredients, or bonded with the particles of the first powder coating component. Alternatively, or additionally, they can be separately dry blended with the first and second powder coating components as additional dry-blended powder coating components.

Additional dry-blended powder coating components (i.e. in addition to the first and second powder coating components) can be inorganic particulate components. For example, they can be selected from inorganic particulate materials that provide functionality to the powder coating composition, for example inorganic colour pigments, inorganic effect pigments such as metal effect pigments, biocidal pigments, anticorrosive pigments, extenders, opacifying pigments, conductive or anti-static pigments, infrared-absorbing pigments, radiation shielding pigments, glass flakes, abrasion resistance agents or any combination of two or more thereof.

The total amount of dry-blended additional components can be up to 35 wt %, for example up to 30 wt % or up to 25 wt %.

### [Improved Effects]

A particular advantage of the present disclosure is that additional dry blended components can be incorporated at higher concentrations than previously possible, without causing inhomogeneities in the resulting coating. This means that it is not always necessary to melt-mix or bond them with binder-containing particles. This is particularly advantageous for additives that are conventionally bonded with the first powder coating particles (e.g. effect pigments), since it avoids the need for a separate heating step. In addition, higher overall quantities of the effect pigment (and/or other additive particles) can be included in the powder coating composition. For example, bonded effect pigment can typically only be included at concentrations of up to 5 or 6 wt % based on the amount of the first powder coating component (i.e. the binder-containing particles particles). In the present disclosure, embodiments can include much higher concentrations (e.g. up to 35 wt %) based on the total weight of the powder coating composition. In addition, it is sometimes not possible to incorporate components such as effect particles during melt-mixing and extrusion, since they can get damaged and distorted.

The disclosure is particularly useful for coatings which comprise effect pigments, for example metallic, pearlescent, luster, or glamour effect pigments. These are often based on plate-like inorganic particles, for example mica or metallic particles. For brevity, these may be abbreviated herein to “effect particles”.

Typically, to avoid separation issues, such effect particles tend to be bonded to or otherwise incorporated into the binder-containing particles of the curing system. Otherwise, if merely dry blended, they tend to separate easily from the rest of the composition. For example, they can preferentially stick to the walls of storage containers or spraying equipment. In addition, they can also preferentially migrate to a substrate surface, particularly earthed substrates, causing reduced adhesion for the rest of the powder coating particles. This can also lead to inhomogeneities in colour or appearance, such as “picture framing” effects around substrate imperfections.

In the present disclosure, the use of the second powder coating component avoids these effects, substantially reducing adhesion of the additional dry blended particles (e.g. effect particles) to vessel or equipment walls, and providing a much more even and consistent lay-down during spray application, giving improved homogeneity in both colour and other appearance effects (e.g. metallic or sparkle effects from metal effect particles). It also avoids loss of adherence of the powder particles.

Therefore, in embodiments, the powder coating composition comprises one or more effect pigments, e.g. inorganic effect pigments (such as metallic effect pigments or pearlescent effect pigments), as dry-blended additional powder coating components. In further embodiments, the first powder coating component additionally comprises one or more bonded effect pigments.

The powder coating composition, in embodiments, comprises one or more effect pigments at a total concentration in the range of from 1.0 to 35 wt % based on the total weight of powder coating composition, such as from 3.0 to 30 wt %, for example 7 wt % to 30 wt %. In embodiments, the upper limit is 20 wt % or below. The total effect pigment concentration includes the sum of dry-blended effect pigments, and any effect pigments bonded to or melt-mixed with the first powder coating component.

The effect pigment particles can be dry-blended with the powder particles of the first and second powder coating components. In further embodiments, at least a portion of the effect pigment is bonded with the particles of the first powder coating component. In embodiments, at least 1 wt % of the effect pigment is dry blended, based on the total weight of the powder coating composition, for example at least 3 wt %. In embodiments, the amount of dry blended effect pigment can be up to 35 wt %, for example up to 25 wt %. Thus, ranges for dry blended effect pigment can be in the range of from 1 to 35 wt %, for example from 3 to 35 wt %, from 1 to 25 wt % or from 3 to 25 wt %. In embodiments, the upper limit is 20 wt % or 15 wt %.

In embodiments, the effect pigment is a metallic effect pigment, which can optionally be a metal or metal alloy. In embodiments, the metal can be selected from aluminium, aluminium alloy, stainless steel, copper, tin, bronze and brass. The metal can be in flake form, and can be selected to produce various metallic effects including those referred to as “metallic”, “effect”, “luster”, “glamour” or “pearlescent” effects. Metallic effect pigments can also be non-metal compounds, for example being selected from mica and borosilicates.

In embodiments, the effect pigment particles can be coated, for example being coated with silica or other inert inorganic material for increasing chemical resistance and durability. Alternatively, the particles may be coated with a plastic material for similar purposes, for example an acrylic, PFTE, or a thermosetting plastic material. In other embodiments, the particles may be provided in a polymer or plasticizer which is compatible with the film-forming binder of the powder coating composition. In further embodiments, the effect pigment particles may be coated with a colouring agent such as a metal oxide pigment, e.g. iron oxide, to provide special colour effects.

Effect pigments such as metallic effect pigments are well-known and commercially available. Suitable examples of commercially available metallic effect pigments include Standart PU Aluminium Powder (ex. Eckart), and SILBERCOTE PC X (ex. Silberline).

Such metallic effect pigments are typically in the form of flakes or plate-like particles, as powder or as granules. In embodiments, they are flakes or plate-like particles. In embodiments, the metallic effect pigments are coated or uncoated aluminium flakes. In other embodiments, they are plate-like inorganic oxide or mixed oxide particles (such as the above-mentioned mica or borosilicates). The volume average particle size of the metallic effect pigment (Dᵥ50) can be in the range of from 10 to 100 μm, such as in the range of from 15 to 50 μm.

### [Inorganic Particulate Components]

Separate to any effect pigments, the powder coating composition in embodiments can comprise at least one dry blended inorganic particulate additional component. In further embodiments, the inorganic particulate additional component consists of inorganic components i), ii), and iii), wherein:
component i) is non-coated aluminium oxide or non-coated silica;
component ii) is aluminium hydroxide and/or aluminium oxyhydroxide; and
component ill) is silica.

Such a dry-blended inorganic particulate additive comprises a first silica and a second silica wherein the first silica is a surface-treated silica with a negative tribocharge, and the second silica is non-coated silica or is a surface-treated silica with a positive tribocharge.

Thus, if component i) is non-coated silica, component iii) does not comprise non-coated silica. If component i) is non-coated aluminium oxide, component iii) comprises the first silica and the second silica. If component i) is non-coated silica, component iii) comprises a surface-treated silica with a negative tribocharge. Preferably, component iii) comprises the first silica and the second silica.

A silica with a negative tribo charge is itself negatively tribocharged through contact with other dissimilar particles, yet imparts a negative electric charge on the powder coating particle when mixed due to particle-particle adhesion and wrapping of the powder particle.

A silica with a positive tribo charge is itself positively tribocharged through contact with other dissimilar particles, yet imparts a positive electric charge on the powder coating particles when mixed due to particle-particle adhesion and wrapping of the powder particle.

The charge that a silica will impart on a powder coating particle can be determined by mixing the silica with particles of the powder coating component and then determining on which electrode (negative or positive) the mixture preferentially deposits.

Suitable types of inorganic particle additional components are described for example in WO2021/245043, WO2021/245044, WO2021/245045 and WO2021/245046.

Dry-blended inorganic particulate additives may be surface-treated with an organic compound to modify their surface properties.

The various components of the powder coating composition are typically dry-blended together in a powder tumbler or other suitable mixing device. The components may be added to each other simultaneously or separately.

Without wishing to be bound to any theory, it is believed that the second powder coating component adopts a more negative triboelectric charge compared to the other powder coating components, such that it preferentially binds to a substrate surface, particularly earthed surfaces that tend to carry a positive electric charge. This avoids separation of the other dry-blended powder coating components from each other, Improving homogeneity of their distribution. One way of achieving this is to ensure that their particle size (i.e. their Dᵥ90 and Dᵥ50 values) is smaller than at least the first powder coating component, and in embodiments smaller than all the other dry-blended powder coating components.

The terms coated and surface-treated in connection with particles of the powder coating composition are used herein interchangeably.

### [Coating Application]

The substrate may be any substrate suitable for powder coating, for example metal, wood, plastic, or substrates comprising any of these materials. In embodiments, the substrate is a metal substrate.

Prior to applying the powder coating composition, the substrate surface may be treated to remove any contaminants and/or to improve corrosion resistance of the substrate. Such surface treatments are well known in the art and commonly applied to surfaces to be coated with powder coatings.

The powder coating composition according to the disclosure may be applied as a topcoat over a first layer of powder coating composition. The first layer may then be a powder coating composition different to those described herein. Thus, in one embodiment, the substrate is coated with a first layer of a first powder coating composition, followed by a second layer of powder coating composition according to the present disclosure.

The powder coating composition can be applied with any application technique known in the art, such as fluid bed application or spray application, preferably spray application with a corona gun.

The disclosure will now be illustrated by the following non-limiting examples.

### Examples

### [First Powder Coating Components (Bonded Particles)]

Powder coating particles (that are used as the first powder coating components) were prepared by melt-mixing and extruding the constituent components (except for the effect pigment), and then grinding the cooled hardened extrudate to form melt-extruded particles. Effect pigment was then bonded to these “melt-extruded particles” as described above to form “bonded particles”.

The main ingredients used in forming the bonded particles are listed in Table 1, and the amounts used in Table 2.

TABLE 1
Main Ingredients of Bonded Particles
(First Powder Coating Component)

| | |
|---|---|
| Hydroxy-functional polyester resin | Uralac ™ P1680 |
| Carboxy-functional polyester resins | (a) acid number 11-13 mg KOH/g |
| | (b) acid number 24-26 mg KOH/g |
| | (c) acid number 58.5-61.5 mg KOH/g |
| Fluoropolymer resin | Lumiflon ™ LF-710F |
| Adhesion Promoter | Dodecanedioic acid |
| β-hydroxylamide-based hardening | Prosid ™ H |
| agents | |
| Polyisocyanate-based hardening | (a) Vestagon ™ B 1530 |
| agents | (b) Crelan ™ EF 403 |
| Mica-based effect pigments | (a) Symic ™ PCE C393 |
| | (b) Iriodin ™ 9307 |
| | (c) Iriodin ™ 9522 |

TABLE 2
Composition of Bonded Particles
(First Powder Coating Component)

| Component | 1A | 1B | 1C | 1D |
|---|---|---|---|---|
| Hydroxy-functional polyester resin | — | 33.5 | 33.8 | 33.8 |
| Carboxy-functional polyester resin (a) | 19.2 | — | — | — |
| Carboxy-functional polyester resin (b) | 19.2 | | | |
| Carboxy-functional polyester resin (c) | 36.4 | | | |
| Fluoropolymer resin | — | 31.1 | 31.4 | 31.4 |
| Crosslinker | — | 0.8 | 0.8 | 0.8 |
| β-hydroxylamine hardener | 4.4 | 1.0 | 1.0 | 1.0 |
| Polyisocyanate hardener (a) | — | 8.6 | 8.7 | 8.7 |
| Polyisocyanate hardener (b) | — | 6.1 | 6.2 | 6.2 |
| Effect Pigment (a) | 4.0 | 2.4 | 0.7 | 0.1 |
| Effect Pigment (b) | — | 2.4 | 0.7 | 0.1 |
| Effect Pigment (c) | — | — | 2.4 | 3.6 |
| Fillers and pigments | 13.4 | 7.9 | 8.0 | 8.0 |
| Remainder [1] | 3.4 | 6.2 | 6.3 | 6.3 |
| Dv50 (μm) | 38 | 38 | 38 | 38 |
| Dv90 (μm) | 65 | 65 | 65 | 65 |

[1] Total of surface modifiers, degassing agents, antioxidants and rheology modifiers

### [Second Powder Coating Component]

These were jet milled particles comprising organic polymer/resin and crosslinker in the ratios set out in Table 3. They are dry-blended with other powder coating components to form the powder coating compositions.

TABLE 3
Properties of Polymeric Particles
(Second Powder Coating Component)

| Component | 2A | 2B |
|---|---|---|
| Resin | Polyester | Polyester |
| Resin Content (wt %) | 94.1 | 74.2 |
| Crosslinker (wt %) | 3.3 [1] | 13.5 [2] |
| Dv50 (μm) | 3.50 | 5.12 |
| Dv90 (μm) | 5.77 | 7.65 |

[1] beta-hydroxy alkylamide (HAA)
[2] cycloaliphatic polyuretidione

### [Inorganic Particulate Components]

These are blends of various inorganic oxides and hydroxides, which are then dry-blended with other powder coating components to form the powder coating compositions. Relevant details are listed in Table 4.

Nano-sized particles were prepared by dry mixing aluminium oxide and aluminium hydroxide together and blending in a high shear Waring blender for 3 minutes. Silica (where used) was then added to the blender, and the contents mixed under high shear for a further 1 minute.

TABLE 4
Properties of Inorganic Particulate Components (wt %)

| Component | 3A | 3B | 3C |
|---|---|---|---|
| Aluminium hydroxide | 90 | 68 | 60 |
| Aluminium oxide | 10 | 22 | 20 |
| Fumed silica | — | 10 | 20 |

### [Powder Coating Compositions]

These were formed by dry blending the components mentioned above in the quantities shown in Table 5. Dry blending was carried out using a laboratory scale turbo mixer operating for 5 minutes at 500 rpm.

TABLE 5
Powder Coating Compositions (wt %)

| | Example | | | | | | | |
|---|---|---|---|---|---|---|---|---|
| Components | 1* | 2 | 3* | 4 | 5 | 6 | 7 | 8 |
| First Powder Coating Component | | | | | | | | |
| 1A | 90.5 | 89.7 | 94.8 | 94.5 | 89.3 | — | — | — |
| 1B | — | — | — | — | — | 95.8 | — | — |
| 1C | — | — | — | — | — | — | 93.8 | — |
| 1D | — | — | — | — | — | — | — | 93.6 |
| Second Powder Coating Component | | | | | | | | |
| 2A | — | 4.5 | — | — | — | — | — | — |
| 2B | — | — | — | 2.0 | 4.0 | 4.0 | 6.0 | 6.0 |
| Inorganic Particulate Component | | | | | | | | |
| 3A | 0.5 | 0.9 | 0.2 | — | — | — | — | — |
| 3B | — | — | — | 0.3 | 0.4 | 0.2 | 0.2 | 0.4 |
| 3C | — | 0.4 | — | — | — | — | — | — |
| Effect Pigment Component | | | | | | | | |
| Symic ™ PCE C393 | 9.1 | 4.5 | — | 3.2 | 6.3 | — | — | — |
| Iriodin ™ 9522 | — | — | 5.0 | — | — | — | — | — |
| Total Effect Pigment | 12.7 | 8.1 | 8.8 | 7.0 | 9.9 | 4.6 | 3.6 | 3.6 |
| (bonded + dry blended) | | | | | | | | |

*Comparative Example

### [Experiment 1—Coating Uniformity]

Steel panels were coated at 40 KV and 80 KV using a hand-held corona spray gun. The appearance was checked for uniformity of coating. The panels at different voltages were also checked for variations in colour consistency, and consistency of sparkling effect.

Examples 2 and 4-8 all showed very good uniformity and high coverage of coating of the panels at both voltages, including at the panel edges. There was also no difference in colour and sparkling effect between the panels coated at the different voltages.

Comparative examples 1 and 3 on the other hand showed poor coating consistency at both voltages, with little or no coverage at the edges of the panels, and high areas of non-uniformity generally on the face of the panel. The colour and sparkle effect also varied widely between panels coated at different voltages.

### [Experiment 2—Electrostatic Adhesion]

Steel panels were coated at 60 KV and 80 KV using a hand-held corona spray gun. An edge of each panel was then tapped three times against the floor of the spray booth, and the extent of coating loss was observed.

Examples 2 and 4-8 showed very little loss of powder coating from the panels, the vast majority remaining on the panels. Comparative Examples 1 and 3 on the other hand showed substantial loss of powder coating from the panels, with large patches of bare substrate.

### [Experiment 3—Contamination]

A visual inspection of the powder coating blending equipment was undertaken to see how much contamination from the mica-based effect pigment took place. Contamination with effect pigment is problematic when the equipment needs to be used with different coloured powder coatings, or coatings with different effect pigments.

Examples 2 and 4-8 caused very low amounts of contamination from the effect pigment. There was a light coating of fine particles from the second powder coating component, but the contamination was easily removed by blowing compressed air over the surface. On the other hand, Comparative Examples 1 and 3 left large amounts of effect pigment on the surfaces, which was not easily removed even after compressed air treatment.

The spray equipment was also visually inspected. For the examples, there was again little to no contamination by effect pigment. As with the mixing vessel, there was some light coating by the fine particles of the second powder coating component of the earthed areas of the fluid bed portion of the spray equipment, and also on the walls of the spray booth. However, this was easily removed using compressed air. Conversely, the Comparative Examples left large deposits of effect pigment on the earthed parts and porous plate of the fluidized bed unit of the spray equipment. In addition, the effect pigment was seen to deposit preferentially on the walls and floor of the spray booth. Table 6 summarises the coating characteristics of the powder coating examples.

TABLE 6
Coating Characteristics

| | Example | | | | | | | |
|---|---|---|---|---|---|---|---|---|
| | 1* | 2 | 3* | 4 | 5 | 6 | 7 | 8 |
| Coating Uniformity 40 kV | Poor | Good | Poor | Good | Good | Good | Good | Good |
| Coating Uniformity 60 kV | Poor | Good | Poor | Good | Good | Good | Good | Good |
| Colour Consistency 40 kV/60 kV | Poor | Good | Poor | Good | Good | Good | Good | Good |
| Sparkle Effect Consistency 40 kV/60 kV | Poor | Good | Poor | Good | Good | Good | Good | Good |
| Coating Adhesion 60 kV | Poor | Good | Poor | Good | Good | Good | Good | Good |
| Coating Adhesion 80 kV | Poor | Good | Poor | Good | Good | Good | Good | Good |
| Contamination by Effect Pigment | High | Low | High | Low | Low | Low | Low | Low |

1. A powder coating composition comprising a first powder coating component dry blended with a second powder coating component, wherein the first powder coating component comprises a curable resin, and the second powder coating component comprises a powdered organic polymer or resin with a particle size distribution in which the Dᵥ90 value and/or the Dᵥ50 value is less than that of the first powder coating component, and in which the Dᵥ90 value of the second powder coating component is 50 μm or less and/or the Dᵥ50 value of the second powder coating component is 30 μm or less.

2. The powder coating composition according to claim 1, comprising one or more curing additives for curing the curable resin.

3. The powder coating composition according to claim 2, in which one or more curing additives are present in the first powder coating component.

4. The powder coating composition according to claim 1, in which the particles of the first powder coating component have a particle size distribution in which the Dᵥ90 is at most 150 μm and/or the Dᵥ50 is at most 75 μm.

5. The powder coating composition according to claim 4, in which the particles of the first powder coating component have a particle size distribution according to one or more of the following:
a Dᵥ90 value of at most 120 μm;
a Dᵥ90 value of at least 30 μm or at least 40 μm;
a Dᵥ90 value in the range of from 30 to 150 μm or from 40 to 120 μm;
a Dᵥ50 value of at most 50 μm or 40 μm;
a Dᵥ50 value of at least 20 μm or 30 μm;
a Dᵥ50 value in the range selected from 20 to 75 μm, 20 to 50 μm, 20 to 40 μm, 30 to 75 μm, 30 to 50 μm, and 30 to 40 μm.

6. The powder coating composition according to claim 1, in which the particles of the second powder coating component have a particle size distribution according to one or more of the following:
a Dᵥ90 value of at most 40 μm, 30 μm or 25 μm;
a Dᵥ90 value of at least 3 μm or 5 μm;
a Dᵥ90 value in the range selected from 3 to 50 μm, 5 to 40 μm, 5 to 30 μm, and 5 to 25 μm;
a Dᵥ50 value of at most 25 μm, 20 μm or 10 μm;
a Dᵥ50 value of at least 1 μm;
a Dᵥ50 value in the range selected from 1 to 30 μm, 1 to 25 μm, 1 to 20 μm and 1 to 10 μm.

7. The powder coating composition according to claim 1, in which the first powder coating component comprises either:
(i) a curable resin selected from carboxy- and hydroxy-functional polyester resins, and a curing additive selected from β-hydroxyalkylamides and polyisocyanates;
(ii) a curable resin selected from cross-linkable polyesters, and a curing additive selected from epoxy resins; or
(iii) a curable resin selected from epoxy resins, and a curing additive selected from polyamine resins.

8. The powder coating composition according to claim 1, in which the second powder coating component comprises one or more organic polymers or resins selected from polyesters and polyurethanes.

9. The powder coating composition according to claim 1, additionally comprising one or more additives.

10. The powder coating composition according to claim 9, in which at least a portion of the one or more additives are dry blended as additional powder coating components.

11. The powder coating composition according to claim 9, in which at least one additive is an effect pigment, at least a portion of which is dry blended as an additional powder coating component.

12. The powder coating composition according to claim 1, in which the effect pigment is inorganic.

13. The powder coating composition according to claim 1, in which the triboelectric charge of the second powder coating component is more negative than that of the first powder coating component and also of any dry-blended additional powder coating components.

14. A substrate coated with a powder coating composition according to claim 1.

15. A method of coating a substrate comprising applying to the surface of the substrate a powder coating composition according to claim 1 and curing the powder coating composition.
